(19) United States
(12) Patent Application Publication
(10) Pub. No.: US 2009/0073353 A1
(43) Pub. Date: Mar. 19, 2009

(54) Optical Film and Liquid Crystal Display

(76) Inventors: Liang-Bin Yu, Sinjhuang City (TW); Yi-Han Chao, Fing-Zhen Industrial Park (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/854,595

(22) Filed: Sep. 13, 2007

(51) Int. Cl. G02F 1/1335

(52) U.S. Cl. 349/96

(57) ABSTRACT

An optical film and a liquid crystal display are provided. The liquid crystal display includes a twisted nematic type liquid crystal panel and a backlight module. The liquid crystal panel includes a bottom polarizer, a liquid crystal cell, and a top polarizer. The liquid crystal cell is placed between the bottom polarizer and the top polarizer. The backlight includes a reflective polarizer and a half-wave plate, and the half-wave plate is placed on the reflective polarizer. The transmission axis of the bottom polarizer and the principle axis of the bottom polarizer differ a first angle. The transmission axis of the bottom polarizer and the reflective polarizer differ a second angle. The first angle is half of the second angle.

### BACKGROUND OF THE INVENTION

1. Field of the Invention

The present invention relates to a liquid crystal display and particularly to a liquid crystal display equipped with a half-wave plate.

2. Description of the Prior Art

In recent years the traditional cathode ray tube display (commonly called CRT display) is being gradually replaced by liquid crystal display (LCD). This is mainly because the LCD releases far less radiation than the CRT display, and the production cost of LCD also drops significantly in recent years. In general, LCD consists of two main elements, namely a backlight module and a liquid crystal panel. The backlight module mainly aims to provide light to the LCD.

Refer to FIG. 1 for a conventional LCD. The LCD 1000 includes a backlight module 1100 and a liquid crystal panel 1200. The backlight module 100 includes a casing 1110, a plurality of lamps 1120, a diffusion plate 1130, a brightness-enhancement film (BEF for short) 1140 and a reflective polarizer 1150. The lamps 1120 are located in troughs 1112 formed on the casing 1110 with the surface coated with a reflective material. The diffusion plate 1130 contains a plurality of diffusion particles. The BEF 1140 has a plurality of prism-shaped structures 1142 located at an upper side thereof. The liquid crystal panel 1200 includes a bottom polarizer 1210, a top polarizer 1210′, a bottom glass substrate 1220, a top glass substrate 1220′, a top alignment film 1230, a bottom alignment film 1230′ and a liquid crystal layer 1240.

As the troughs 1112 are coated with the reflective material on the surface, light emitted from the lamps 1120 can be converged to project to the diffusion plate 1130, and the diffusion particles in the diffusion plate 1130 fully mix the incident light to make luminosity more uniform. Moreover, the prism-shaped structures 1142 on the BEF 1140 can converge light. The reflective polarizer 1150 is located above the BEF 1140. Polarized light in a direction same as the transmission axis of the reflective polarizer 1150 can pass through the reflective polarizer 1150, while the polarized light in a direction perpendicular to the transmission axis of the reflective polarizer 1150 is reflected by the reflective polarizer 1150.

For the twisted nematic type (commonly called TN) liquid crystal panel 1200, the direction of the transmission axis of the bottom polarizer 1210 must be same as that of the reflective polarizer 1150 to allow the polarized light that passes through the reflective polarizer 1150 also to pass through the bottom polarizer 1210. The liquid crystal layer 1240 is formed by stacking multiple layers of liquid molecules. The layout direction of the liquid crystal molecules at the top layer and the bottom layer form an angle with one side of the bottom alignment film 1230′.

In addition, when the type of the liquid crystal panel differs, the direction of the transmission axes of the bottom polarizer 1210 and the reflective polarizer 1150 generally also are different. For instance, on the TN type liquid crystal panel 1200 the direction of the transmission axes of the bottom polarizer 1210 and the reflective polarizer 1150 and two sides of the bottom polarizer 1210 form an included angle of 45 [symbol] (under the condition of the bottom polarizer 1210 formed in a square). However, for a vertial alignment (VA for short) the liquid crystal panel, the direction of the transmission axes of the bottom polarizer and the reflective polarizer are parallel with two sides of the bottom polarizer.

At present fabrication of the reflective polarizer 1150 is done by first fabricating a raw film, then cutting the raw film to produce individual sheets of the reflective polarizer 1150. Refer to FIG. 2A for an approach to form the reflective polarizer by cutting the raw film. The raw film 10 has a transmission axis in the direction X₁. On the reflective polarizer 1150 of the VA type liquid crystal panel, the direction X₂ of the transmission axis is parallel with one side of the reflective polarizer 1150. Hence cutting along the broken liens shown in FIG. 2A can get the desired reflective polarizer 1150.

Refer to FIG. 21 for another approach to form the reflective polarizer by cutting the raw film. On the TN type liquid crystal panel the direction of the transmission axis X₂ and one side of the reflective polarizer 1150 form an angle 45 [symbol] , the cutting direction also has to form 45 [symbol] with one side of the raw film 10. As a result, scraps are produced (shown by X in FIG. 2). Hence how to reduce the scraps during cutting the reflective polarizer is an issue remained to be overcome.

### SUMMARY OF THE INVENTION

It is an object of the present invention to provide a liquid crystal display (LCD) including a reflective polarizer which is fabricated with reduced scraps.

To achieve the foregoing object the LCD of the invention includes a TN type liquid crystal panel and a backlight module. The TN type liquid crystal panel includes a bottom polarizer, a liquid crystal cell and a top polarizer. The liquid crystal cell is located between the bottom polarizer and the top polarizer. The backlight module includes a reflective polarizer and a half-wave plate located on the reflective polarizer. The half-wave plate has a principle axis (may further be differentiated to a fast axis and a slow axis) which differs from the transmission axis of the bottom polarizer for a first angle. The reflective polarizer also has a transmission axis which differs from the transmission axis of the bottom polarizer for a second angle. The first angle is one half of the second angle. In one aspect, the second angle in the TN type LCD is π/4.

In another aspect: the half-wave plate in the TN type LCD consists of N sets of ½N wave plates stacking together, where N=2 or 4.

In yet another aspect, in the TN type LCD the transmission axis of the top polarizer crosses with the transmission axis of the bottom polarizer in an orthogonal manner.

Based on the object set forth above, the invention further provides an optical film located in a liquid crystal panel which has a bottom polarizer. The optical film includes a reflective polarizer and a half-wave plate located on the reflective polarizer. The half-wave plate has a principle axis which differs from the transmission axis of the bottom polarizer for a first angle. The reflective polarizer also has a transmission axis which differs from the transmission axis of the bottom polarizer for a second angle. The first angle is one half of the second angle.

After light passes through the half-wave plate, it forms a polarized direction same as the direction of the transmission axis of the bottom polarizer. Hence the transmission axes of the reflective polarizer and the bottom polarizer of the invention do not have to be maintained in the same direction. Thus during fabrication of the reflective polarizer for the TN liquid crystal cutting can adopt the approach shown in FIG. 2A without producing scraps. Hence the cost can be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional LCD.

FIG. 2A is a schematic view of an approach for cutting a raw film to form reflective polarizers.

FIG. 2B is a schematic view of another approach for cutting a raw film to form reflective polarizers.

FIG. 3 is a schematic view showing interactions between a half-wave plate and light.

FIG. 4 is a schematic view of an embodiment of the LCD of the invention.

FIG. 5 is a schematic view showing the positional relationship of the bottom polarizer, top polarizer, liquid crystal cell, reflective polarizer and half-wave plate.

FIG. 6A is a schematic view of a half-wave plate formed by stacking N sets of ½N wave plates.

FIG. 6B is a schematic view of a half-wave plate formed by stacking two sets of quarter-wave plates.

FIG. 6C is a schematic view of a half-wave plate formed by stacking four sets of eighth-wave plates.

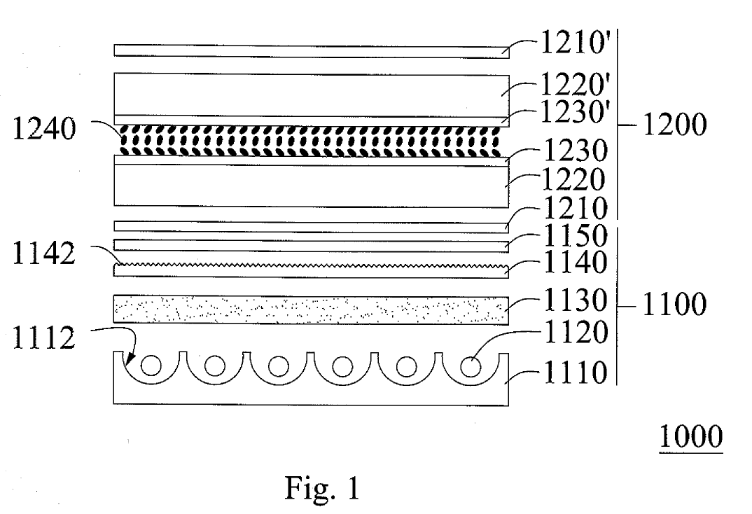

### DESCRIPTION OF THE PREFERRED EMBODIMENTS

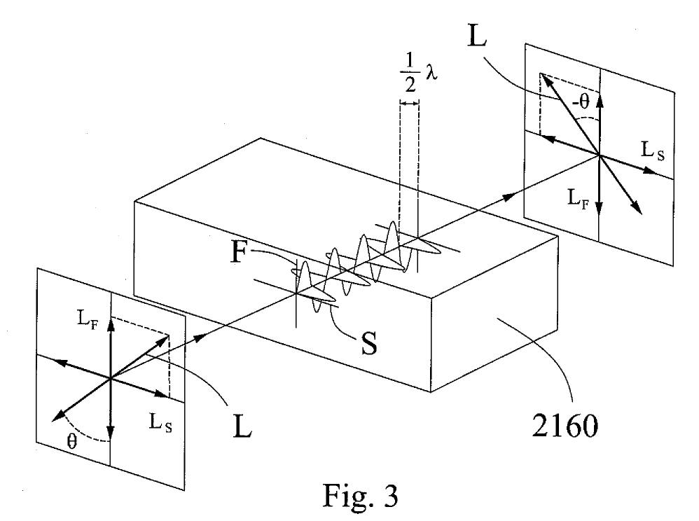

To facilitate discussion of the embodiments below, the operation principle of the half-wave plate is first explained as follow. When light passes through a half-wave plate the travel distance along a slow axis is less than along a fast axis by one half wavelength. Referring to FIG. 3 for interactions of a half-wave plate and light. The half-wave plate 2160 is made from a birefringent material. The birefringent material has a characteristic: polarized light has a different refraction index in the direction of the different principle axes. Moreover, for the polarized light that has a smaller refractive index in the direction of a selected principle axis, light travels at a faster speed. That selected principle axis is called a fast axis F. On the other hand, the polarized light has a greater refractive index when a principle axis is orthogonal to the fast axis, and the light travels at a lower speed. Hence the principle axis orthogonal to the fast axis is called a slow axis S. Referring to FIG. 3, if the fast axis F is taken as a reference axis, the polarized direction of light L and the fast axis F form an included angle θ. Hence the light L has a first light component LF on the fast axis F, and a second light component LS on the slow axis S. As the speed of light LF is faster than light LS , when the light L passes through the half-wave plate 2160 the first light component LF travels at a longer distance than the second light component LS by one half wavelength B. Hence the polarized direction of the light L passing through the half-wave plate 2160 forms an included angle −θ with the fast axis F. As a result, after the light L has passed through the half-wave plate 2160 the polarized direction turns 20. If the slow axis S is taken as the reference axis, two times of tuning angle also is formed.

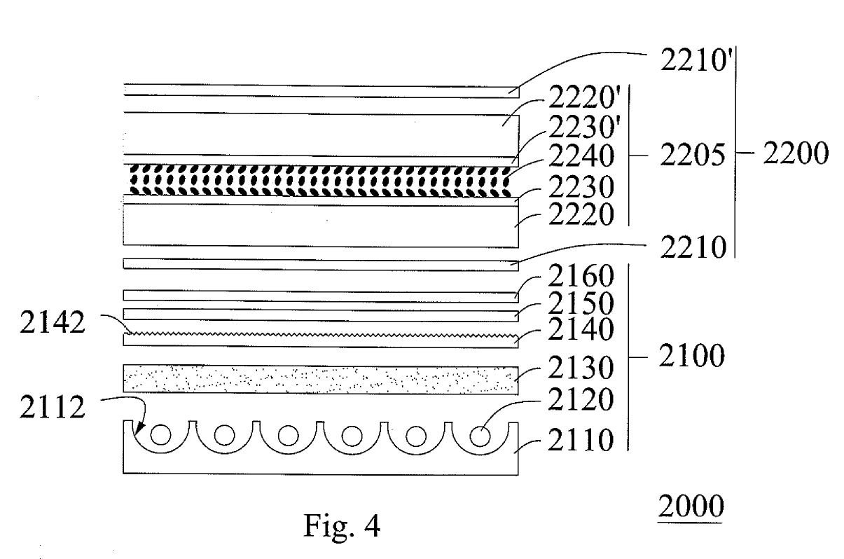

Refer to FIG. 4 for an embodiment of the LCD of the invention. The LCD 2000 includes a backlight module 2100 and a liquid crystal panel 2200. The backlight module 2100 includes a casing 2110, a plurality of lamps 2120, a diffusion plate 2130, a BEF 2140, a reflective polarizer 2150 and a half-wave plate 2160. The lamps 2120 are located in troughs 2112 formed on the casing 2110 with the surface coated with a reflective material. The diffusion plate 2130 contains a plurality of diffusion particles. The BEF 2140 has a plurality of prism-shaped structures 2142 located at an upper side thereof. The reflective polarizer 2150 is located on the BEF 2140 and formed by stacking a plurality of films. A polarized light in the same direction of the transmission axis of the reflective polarizer 2150 can pass through the reflective polarizer 2150, while the polarized light in the perpendicular direction of the transmission axis of the reflective polarizer 2150 is reflected by the reflective polarizer 2150.

The LCD 2200 is a TN type, and includes a bottom polarizer 2210, a top polarizer 2210′, a bottom glass substrate 2220, a top glass substrate 2220′, a top alignment film 2230, a bottom alignment film 2230′ and a liquid crystal layer 2240. The bottom glass substrate 2220, top glass substrate 2220′, top alignment film 2230, bottom alignment film 2230′ and liquid crystal layer 2240 are coupled together to form a liquid crystal cell 2205.

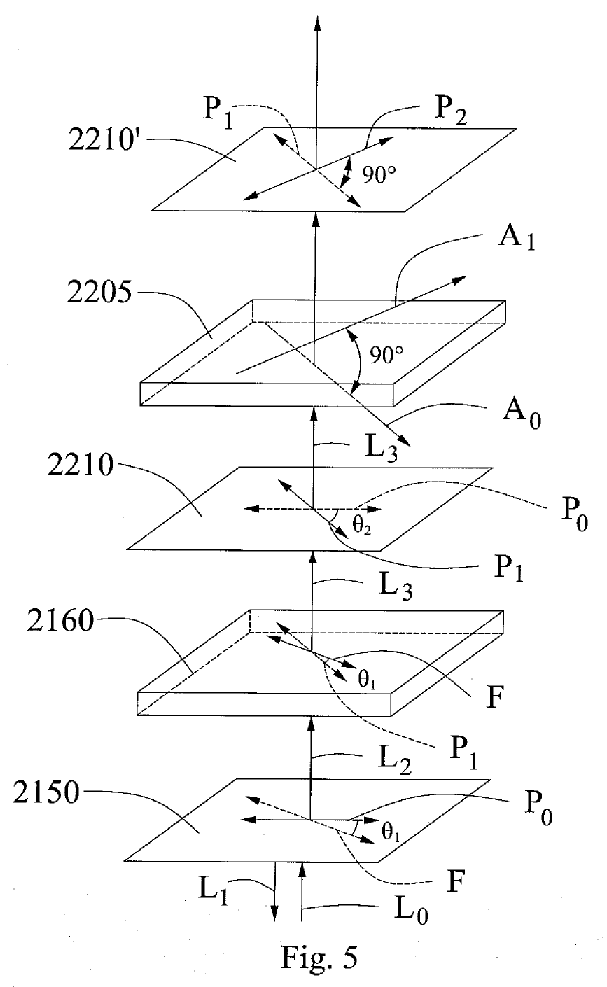

Refer to FIG. 5 for the positional relationship of the bottom polarizer, top polarizer, liquid crystal cell, reflective polarizer and half-wave plate. The top polarizer 2210′ has a transmission axis P₂ crosses with a transmission axis P₁ of the bottom polarizer 2210 in an orthogonal manner, namely differ by an angle of 90 [symbol] . In the liquid crystal cell 2205 the laid direction A₁ of liquid crystal molecules at the top layer is same as the direction of the transmission axis P₂ of the top polarizer 2210′, while the inclined direction A₀ of liquid crystal molecules at the bottom layer is same as the direction of the transmission axis P₁ of the bottom polarizer 2210.

Moreover, the fast axis F of the half-wave plate 2160 and the transmission axis P₁ of the bottom polarizer 2210 differ for a first angle θ₁, while the transmission axis P₀ of the reflective polarizer 2150 and the transmission axis P₁ of the bottom polarizer 2210 differ for a second angle θ₂. The first angle θ₁ is one half of the second angle θ₂. In this embodiment the second angle θ₂. is π/4, while the first angle θ₁ is π/8.

Light L₀ emitted from the lamps 2120 (referring to FIG. 3) projects to the reflective polarized 2150 and generates reactions therewith, in which a second light L₂ with a polarized direction same as the direction of the transmission axis P₀ passes through the reflective polarizer 2150, while a first light L₁ with a polarized direction different from the direction of the transmission axis P₀ is reflected by the reflective polarizer 2150. Moreover, as shown in FIG. 3, when the second light L₂ has passed through the half-wave plate 2160, the polarized direction turns 2θ₁, namely θ₂. Hence a third light L₃ is formed with a polarized direction same as the direction of the transmission axis P₁. As a result the third light L₃ can pass through the bottom polarizer 2210 to reach the liquid crystal cell 2205.

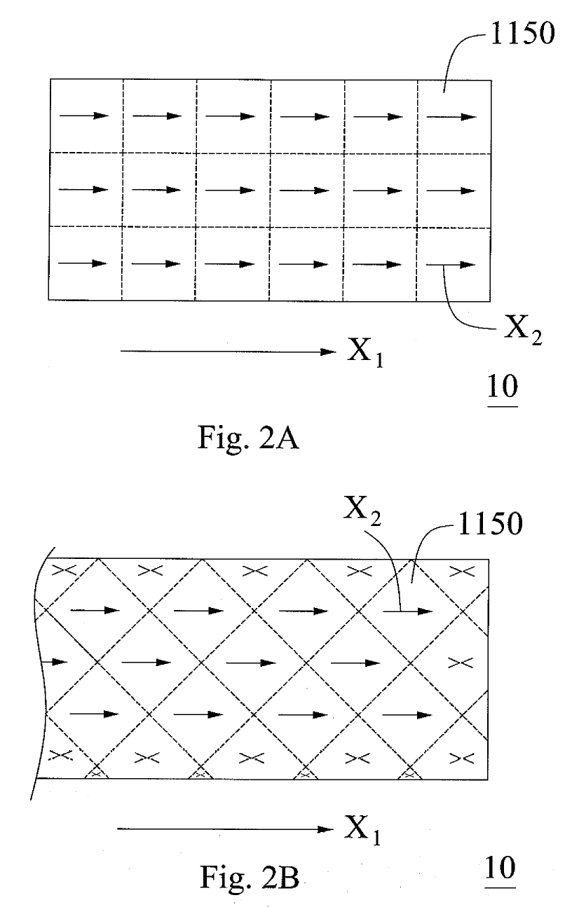

Thus after the second light L₂ has passed through the half-wave plate 2160, the third light L₃ is formed with the polarized direction same as the direction of the transmission axis P₁. Hence the transmission axis P₀ of the reflective polarizer 2150 and the transmission axis P₁ of the bottom polarizer 2210 do not have to be maintained in the same direction. As a result, during fabrication of the reflective polarizer 2150 for the TN type liquid crystal panel, the cutting approach can adopt the one shown in FIG. 2A without producing scraps, therefore the cost can be reduced.

In the embodiment previously discussed, the second angle θ₂. is π/4, and the first angle θ₁ is π/8. However, when the second angle θ₂ between the transmission axis P₀ of the reflective polarizer 2150 and the transmission axis P₁ of the bottom polarizer 2210 is altered, adjusting the first angle θ₁ between the fast axis F of the half-wave plate 2160 and the transmission axis P₁ of the bottom polazer 2210 also allows the light passing through the half-wave plate 2160 to pass through the bottom polarizer 2210. This can be easily seen by those skilled in the art.

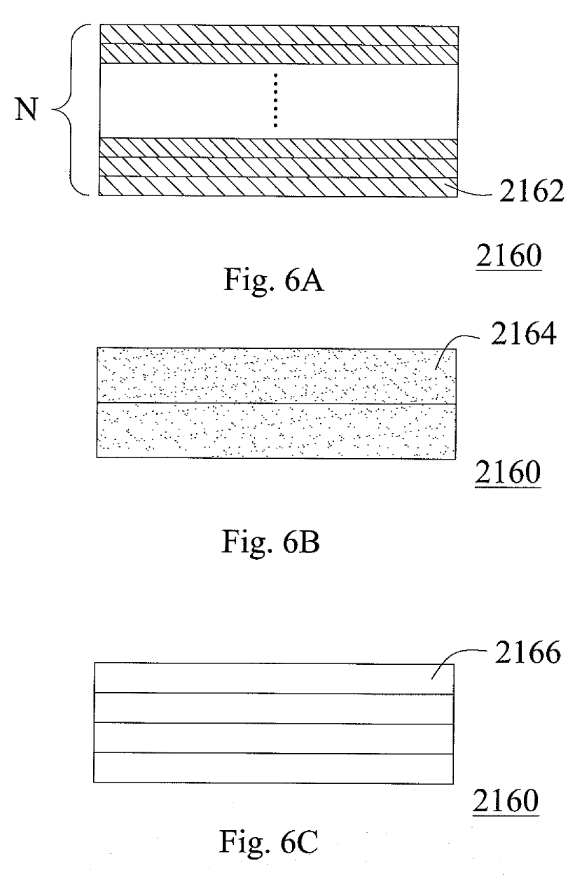

The half-wave plate 2160 previously discussed may be fabricated integrally, also may be formed by stacking N sets of ½N wave plates 2162 (referring to FIG. 6A), where N is a natural number, and the ½N wave plates means that when light passes through the ½N wave plates its travel distance along the slow axis is longer than along the fast axis by ½N wavelength. FIG. 6B illustrates another embodiment in which the half-wave plate 2160 is formed by stacking two pieces of quarter-wave plates 2164, and FIG. 6C illustrates yet another embodiment in which the half-wave plate 2160 is formed by stacking four pieces of eighth-wave plates 2166.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An optical film installed on a liquid crystal panel which has a bottom polarizer, comprising:
a reflective polarizer; and
a half-wave plate located on the reflective polarizer, the half-wave plate having a principle axis which differs from a transmission axis of the bottom polarizer for a first angle; the reflective polarizer having another transmission axis differs from the transmission axis of the bottom polarizer for a second angle the first angle being one half of the second angle.

2. The optical film of claim 1, wherein the second angle is π/4.

3. The optical film of claim 1, wherein the half-wave plate is formed by stacking N pieces of ½N wave plates.

4. The optical film of claim 3, wherein N=2.

5. The optical film of claim 3, wherein N=4.

6. A liquid crystal display, comprising:
a twisted nematic type liquid crystal panel which includes a bottom polarizer, a liquid crystal cell and a top polarizer, the liquid crystal cell being located between the bottom polarizer and the top polarizer; and
a backlight module which includes a reflective polarizer and a half-wave plate located on the reflective polarizer, the half-wave plate having a principle axis and the bottom polarizer having a transmission axis that differs for a first angle; the reflective polarizer having another transmission axis which differs from the transmission axis of the bottom polarizer for a second angle, the first angle being one half of the second angle.

7. The liquid crystal display of claim 6, wherein the second angle is π/4.

8. The liquid crystal display of claim 6, wherein the half-wave plate is formed by stacking N pieces of ½N wave plates.

9. The liquid crystal display of claim 8, wherein N=2.

10. The liquid crystal display of claim 8, wherein N=4.
